(19) United States
(12) Patent Application Publication
(10) Pub. No.: US 2018/0345171 A1
(43) Pub. Date: Dec. 6, 2018

(54) Nutmilk Extraction Bag

(71) Applicants: Elizabeth Hampton, Portland, OR (US); Hari Mark Reyes, Portland, OR (US)

(72) Inventors: Elizabeth Hampton, Portland, OR (US); Hari Mark Reyes, Portland, OR (US)

(21) Appl. No.: 15/613,178

(22) Filed: Jun. 3, 2017

(51) Int. Cl. B01D 11/02; A23C 11/10; B65D 47/12; B65D 33/25; B65D 85/72

(52) U.S. Cl. CPC B01D 11/0219; A23C 11/103; B65D 85/72; B65D 33/2508; B65D 47/122

(57) ABSTRACT

A nut milk extraction bag having two parallel inner compartments. The body of the bag is made from two opposable, polymer, fluid impermeable side sheets having a polymer mesh central sheet continuously affixed across the axial width and near the proximal end of one of the side sheets and continually joined across the axial width near the distal end of the other side sheet. The body of the mesh sheet is free to move between the side sheets. The side edges of all three sheets are continually joined and the distal end of the two side sheets are also continually joined. Across the proximal edge of two side sheets is a reuseable seal. The bag is divided into two volume adjustable inner compartments about its longitudinal axis. A sealable, pourable spout is affixed at the distal end of the bag.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to a device for the extraction of milk from nuts, and more particularly to portable, almond milk press technology.

### BACKGROUND

It is known that nutmilks such as almond milk, is replete with vitamins like calcium, iron, magnesium, phosphorus, potassium, sodium, and zinc. The other nutrients available therein include vitamins such as vitamin C, B-6, thiamine, riboflavin, niacin, folate and vitamin E. All these nutrients have beneficial effects, essential for healthy bodies. One cup of almond milk contains only 60 calories, and has no cholesterol or saturated fat. It's low in sodium and high in healthy fats (such as omega fatty acids, typically found in fish), which helps to prevent high blood pressure and heart disease. One glass has 30 percent of the recommended daily amount, as well as 25 percent of the recommended amount of vitamin D, reducing the risk for arthritis and osteoporosis as well as improving the body's immune function.

Almond milk contains 50 percent of the recommended daily amount of vitamin E, which contains antioxidant properties essential to your skin's health, such as protecting it against sun damage. It is low in carbs, has no lactose and has a low glycemic index. It has almost one gram of fiber per serving, which is important for healthy digestion. Most importantly—it does not require refrigeration.

The downfalls are that it is not readily available everywhere and where it is available, it often is not fresh because of the low demand. Since it is processed in smaller batches it can be expensive. Commercial extraction devices are expensive, large and require a power source. Since almond milk is derived from a nut, it can, in its unprocessed, ground form, be transported anywhere and freshly extracted if one had a portable extraction device.

Henceforth, a portable, unpowered, inexpensive, personal nutmilk extraction device that maximizes the amount of milk that can be extracted from a nut such as an almond, as well as allowing for the storage of the nut fines, would fulfill a long felt need. This new invention utilizes and combines known and new technologies in a unique and novel configuration to overcome the aforementioned problems and accomplish this.

### BRIEF SUMMARY

In accordance with various embodiments, an extremely inexpensive, disposable manually operated, portable nutmilk extraction device is provided.

In one aspect, an inexpensive nutmilk extraction device that can be vacuum packed with the correct mass of nut fines for sale as a complete nutmilk extraction system is provided.

In a further aspect, an inexpensive, portable, optionally disposable nutmilk extraction device that can be prepacked and sealed in itself with nut fines such that it has an indefinite or lengthy self life is provided.

In still another aspect, a nutmilk extraction system for processing personal amounts of nutmilk, that can be prepackaged with the necessary nut fines in a slim, compact profile for storage on the retailer's shelves is provided.

In another aspect, a nutmilk extraction device is provided, capable of visual verification of the extraction process.

In yet another aspect, a nutmilk extraction device is provided that retains the soaked, used nut fines in an airtight storage bag for storage in a refrigerated container.

In yet another aspect, a dishwasher proof, freezable nutmilk extraction bag that has a simplified fabrication method.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components.

FIG. 1 is a front view of a first embodiment nutmilk extraction bag;

FIG. 2 is a front perspective exploded view of the nutmilk extraction bag;

FIG. 3 is a front perspective exploded view of the alternate embodiment nutmilk extraction bag;

FIG. 4 is a bottom view of the udder cap;

FIG. 5 is a top view of the udder cap;

FIG. 6 is a side view of the udder cap;

FIG. 7 is the side view of the udder cap of FIG. 6 rotated 180 degrees;

FIG. 8 is the side view of the udder cap of FIG. 7 rotated 120 degrees; and

FIG. 9 is a bottom perspective view of the udder cap.

### DETAILED DESCRIPTION OF CERTAIN EMBODIMENTS

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers herein used to express quantities, dimensions, and so forth, should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

As used herein, the term “Vacuum Packaging” refers to a form of packaging in which air is withdrawn from the primary package. The usual objective is to remove oxygen from the package. The removal of internal oxygen is often attributed to longer shelf life.

A used herein, the term ‘Modified Atmosphere Packaging ’ refers to a packaging method in which the atmosphere within a package has been altered from the external atmosphere. Atmospheric altering can include the removal of or introduction of a variety of atmospheric gases.

As used herein, the term “heat sealing or welding” refers to any of the chemical or mechanical methods of joining polymers including gluing, melting, electosonic welding, heat staking, heat swaging, electromagnetic and heat welding and solvent/adhesive bonding.

The present invention relates to a novel design for an improved nutmilk extraction system. It is intended to be a complete off-the-shelf system for the extraction of personal amounts of fresh nutmilk, including the appropriate prepackaged amount of nut fines installed in the bag.

The inventor here has set out to develop a complete inexpensive, freezer proof, dishwasher safe, optionally-disposable nutmilk extraction system for the development of personal amounts of nutmilk that requires only water, and that can be retailed in a minimized physical profile having an extremely long if not indefinite shelf life. It is intended for use by those at home, travelling, camping or the like.

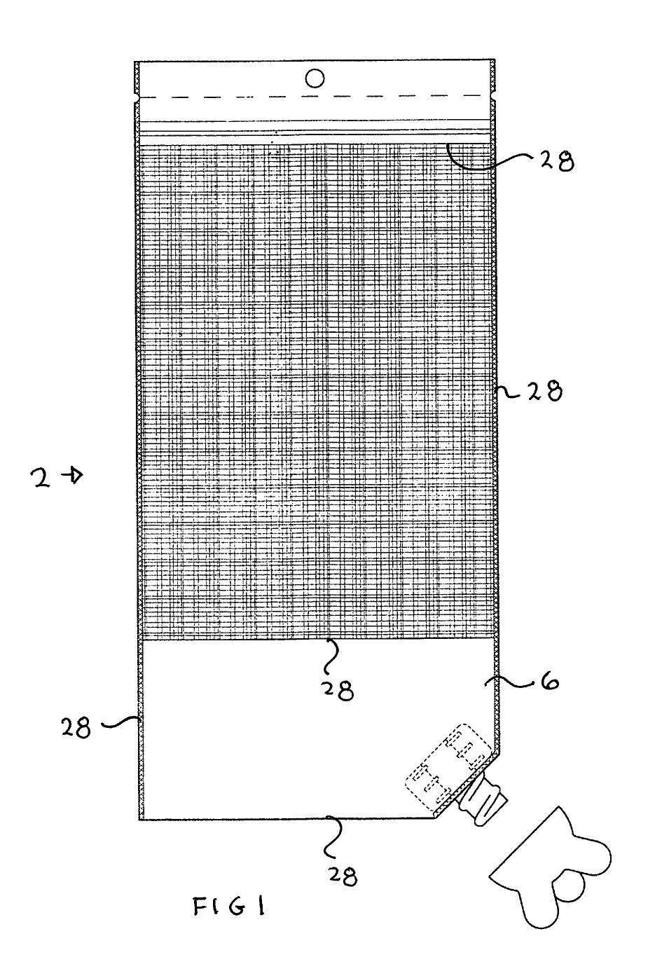

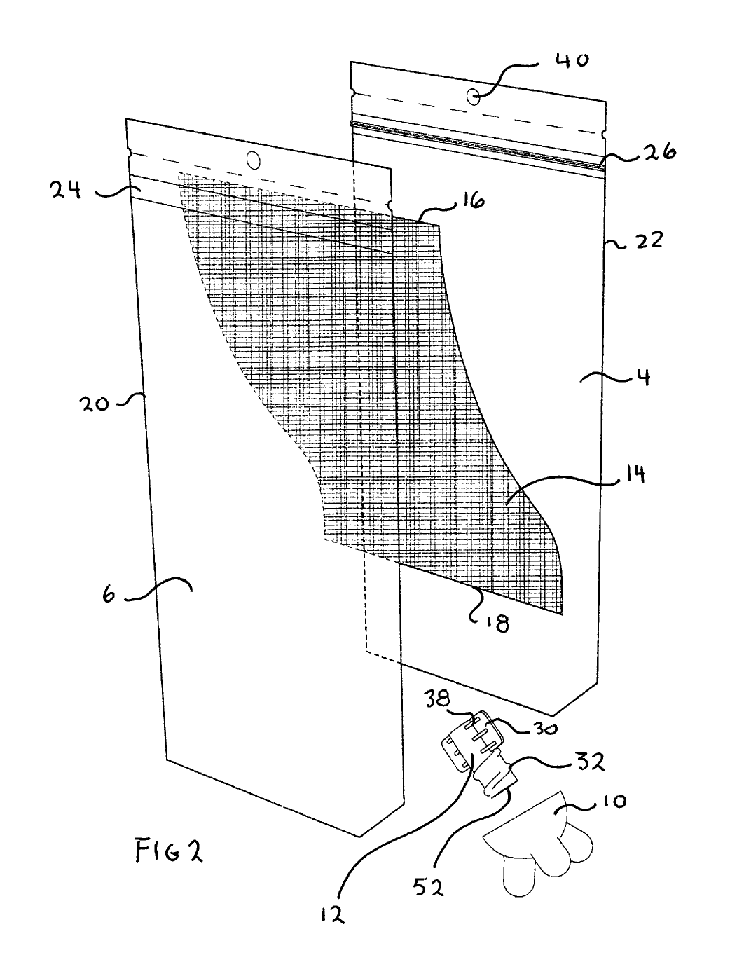

Looking at FIGS. 1 and 2 it can be seen that the first embodiment nutmilk extraction system has a nutmilk extraction bag 2 divided into a first compartment 4 (intended for almond fines) and a second parallel compartment 6 (intended for filtered nutmilk) about its longitudinal axis. Each compartment can vary in its volumetric capacity (size) based on the location of the polymer water permeable mesh 14 within the bag 2. The almond fines are not illustrated. The bag 2 has a diagonally cut corner 8 and a pour device made of an udder cap 10 and a sealable spout 12.

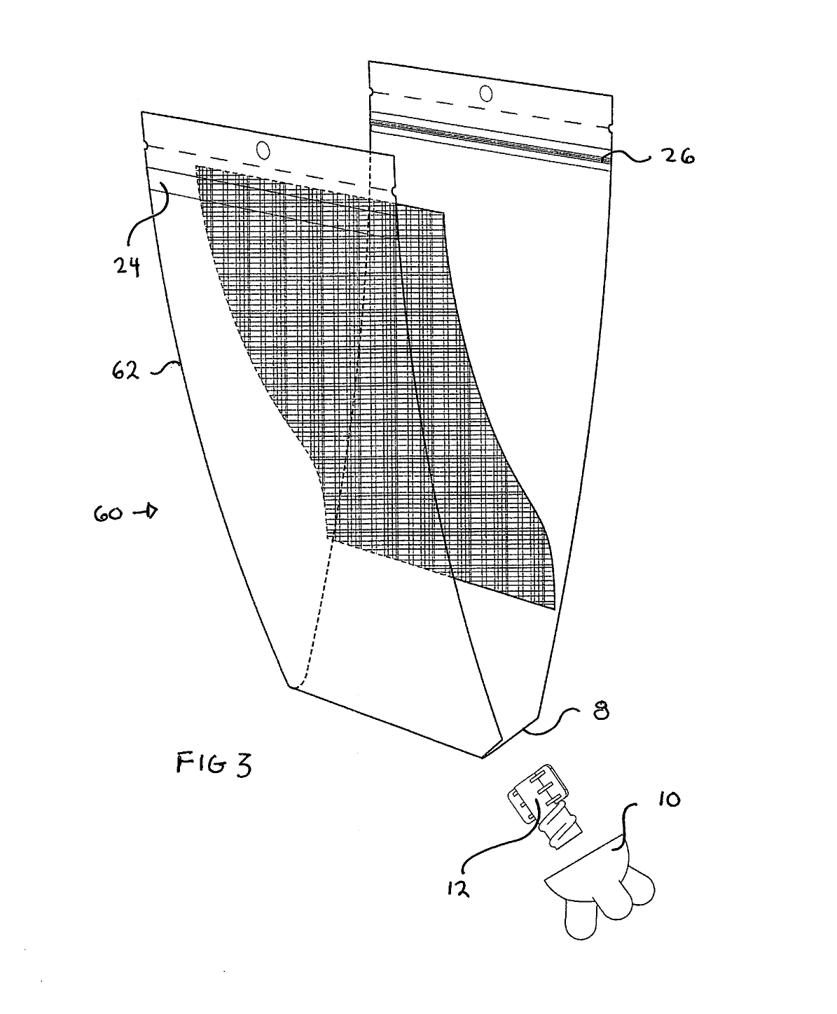

The bag 2 is made of two side sheets of liquid-impermeable polymer, although it can be made of a single side sheet of liquid-impermeable polymer, as in the alternate embodiment of FIG. 3. The polymer of choice is a BPA free, clear polyethylene/nylon plastic, made without PVC and phthalates, preferably of a 5 mil thick multi ply construction such that it can be frozen, microwaved, boiled, refrigerated, and washed in a dishwasher. (Other polymer materials with and without a foil substrate may be used, ranging in thickness from 2-6 mil.) It may be transparent or it may be oblique. The bag 2 has an inner sheet of polymer water permeable mesh 14 joined (by heat sealing/welding 28) continuously at its top edge 16 to the inner face of first side sheet 20, adjacent to the first half top closure seal 24 and continually joined at its bottom edge 18 to the inner face of second side sheet 22 below its longitudinal midpoint. Both of these joined interfaces reside along the axial width of the bag 2. The side edges of the mesh 14 are heat sealed/welded 28 between the side edges of the first side sheet 20 and the second side sheet 22. This forms a first compartment 4 and second compartment 6 in the bag 2. Each compartment has a mesh face and a polymer face. There is thus a mesh barrier compartmentalizing the joined polymer side sheets, not a separate completely mesh enclosed pouch/compartment formed in the bag 2. The first half top closure seal 24 on the first side sheet 20 sealingly engages the second half top closure seal 26 on the second side sheet 22 under compression as is well known in the industry.

The bottom, diagonally cut corner 8 of the bag 2 is sized to accommodate the two heat seal wings 30 in the inner end of the sealable spout 12. These heat sealable wings 30 are generally planar flanges that extend normally from the top (inner) end sealable spout 12. There are four sets of gusset ribs 38 formed between the cylindrical body of the spout 12 and the face of the gusset ribs 38. The sealable spout is a cylindrical tube with an internal through bore (not visible). It has a thread 32 formed on its bottom outer end configured to be matingly engaged with the internal thread 34 of the udder cap 10. The upper, inner end of the spout 12 is inserted into the cut corner 8 of the bag 2 and the two side sheets 20 and 22 heat sealed onto the heat sealable wings 30. The gusset ribs 38 stabilize the spout 12 and prevent it from turning and breaking the heat seal formed between the spout 12 and the side sheets 18 and 20 when the udder cap is manipulated. (They provide a larger surface area over which to distribute the torque of a turning udder cap.)

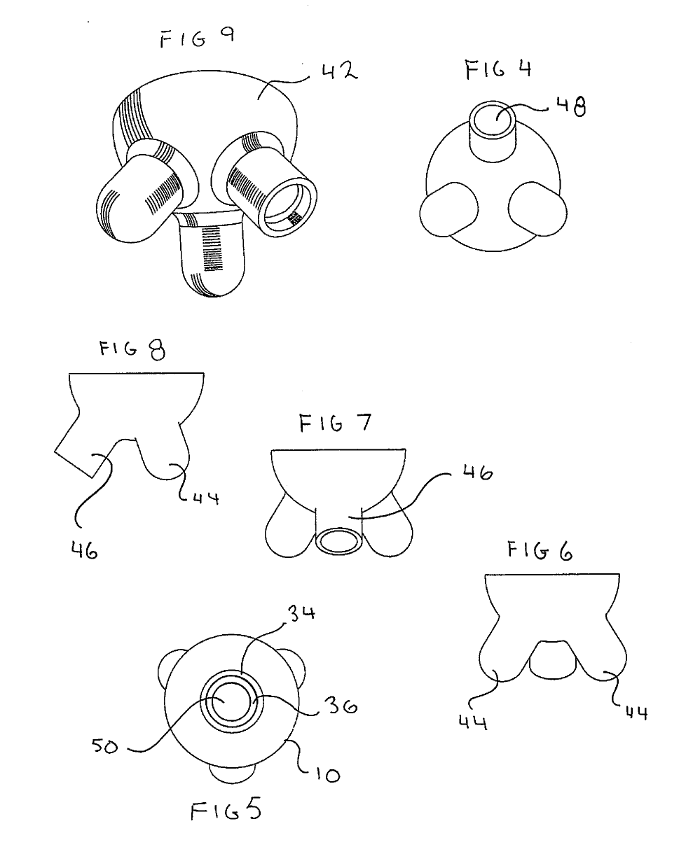

The udder cap 10 is best explained in reference to FIGS. 4-9. Here it can be seen that it has a main hemispherical body 42 with three nipples extending normally therefrom spaced 120 degrees apart. There are two sealed nipples 44 and one pouring nipple 46. The pouring nipple 46 has a longitudinal bore 48 formed completely therethrough, ending in a circular open distal end. There is a central orifice 50 formed in the body 42 having a thread 34 formed thereon. The central orifice intersects the longitudinal bore 48. There is a sealing seat 36 formed at the bottom of the body 42 that contacts the tip 52 of the spout 12 and prevents the escape of any fluid from the bag. When the udder cap 10 is rotated, the sealing seat 36 is pulled away from the tip 52 of the spout 12 allowing fluid to flow from the bag 2 and through the udder cap 10, escaping from the longitudinal bore 48 through the pouring nipple. Thus the udder cap 10 is rotatable between an open and closed position.

This design uses two parallel compartments that allow for the increase the volume of each of the compartments as needed. Essentially, the first compartment can be almost the entire size of the bag when the planar face of the water permeable mesh 14 is in contact with the inner face of the first side sheet 20. In this way all of the fluid in the bag 2 is in the first compartment and the nut fines are dispersed enough in this increased volume to allow equal fluid contact to all nut fines. This parallel, two compartment design has several other benefits.

First, bulk packaging will be horizontal boxing, and the position of display will be a vertical hanging dispenser. Since there is an enlarged first compartment 4 rather than an inner pouch bag (as in all the prior art) the almond fines may be distributed in a planar level in the compartment reducing the overall thickness of the bag 2. This allows for a tighter packaging profile and for more bags 2 to be vertically hung on a display peg.

Second, it allows for a more distributed nut fine array such that more water may contact all the nut fines. In the prior art, the central mass of the nut fines encounters less water than the outer nut fines, reducing the overall efficiency of nutmilk extraction. Third, the flat profile allows the first compartment 4 of the bag 2 to be more uniformly compressed or even rolled with a cylindrical object when extracting milk. compact display my be of the first embodiment is best as it can be stacked with an spatial economy. A hanging orifice 40 is formed through the bag 2 adjacent the top edge.

Looking at FIG. 3 the alternate embodiment bag 60 is illustrated. This bag 60 is made of but a single polymer sheet 62 folded at its approximate axial centerline. This is where the diagonal cut corner 8 is placed. The same spout 12 and udder cap 10 are utilized as well as the same type of first half top closure seal 24 and second half top closure seal 26. However here, these seals 24 and 26 are formed on the same side of the single polymer sheet 62 at the proximal and distal ends. All other aspects of the fabrication is the same except the absence of a heat sealing at the bottom of the bag 60 except across the diagonal corner cut 8 over the onto the heat sealable wings 30.

In all embodiments, the nylon/polymer plastic can withstand inked printing, for the UPC and date codes as well as to support advertising. They will be puncture, stretch and tear resistant possibly having a strengthening membrane formed therein the material. It will be able to withstand food grade packing levels as set forth in the standards established by the governing administrative agencies. Nitrogen flushing or modified atmospheric packing may be utilized when sealing the net fines in the bag 2 to eliminate oxygen, enhance shelf life and lower the level of vacuum necessary in the bag.

Looking at all embodiments, bags 2 and 60 have openable and resealable tops and openable resealable bottoms. These embodiments may utilize any of a plethora of different polymer pressure engageable bag seals as these are abundant on the market and well known in the art. It may have a zipper style seal or a single/double/triple pressure engageable pair of ribs as shown in FIGS. 2 and 3 as the second half top closure seal 26. Whichever seal is used, it will be designed to with stand an internal pressure of a minimum of 10 this is what experimentation has shown is 10 times greater than what is needed to extract the nutmilk through a 150-200 mesh size nylon or HDPE filter with the pre-determined mass and size of nut fines.

The bags 2 and 60 have a water permeable mesh 14 that in the preferred embodiment it is a mesh food grade nylon that is electrostatically welded into place, although there are other methods of accomplishing this including gluing and heat sealing.) In the second compartment 4 a mass of nut fines will be deposited. The nut fines will be ground to the optimal size for elucidation of nut milk from the fines yet too large to pass through the 150-200 mesh size nylon or HDPE filter.

The predetermined mass and size of nut fines will be deposited into the second compartment 4 then the bag sealed at one end and vacuum sealed down to the acceptable levels in conformance with the applicable standards. The other end will then be sealed. Optionally, the bag's opening may be sealed and a vacuum nipple installed in the bag's side wall for the purpose of evacuations.

In use the bag's closure seal is opened to allow access to second compartment 4, and water is added. (The almond fines are already present.) The volume of water to be added may varies with the desired thickness of nutmilk. The closure seal is closed and the mash of nut fines and water is allowed to rest. This may be in a refrigerated state of not. It may be for a matter of minutes of for days. It may be shaken or partially filled, manually kneaded then filled to the desired volume. Then the bottom of the bag and attached udder cap 10 is placed over an open vessel, the udder 10 opened and the mash in the upper compartment is gently squeezed forcing the nutmilk, without the nut fines, into the vessel. With all of the nutmilk forced out, the pulp can be compressed or rolled to a higher degree of compression and the fluid extracted into the vessel.

The advantages of this system is that the bag 2 can now be resealed and stored in a refrigerator/freezer until the user is ready to bake with the fines. Alternatively they can empty and clean the bag 2 and reuse it with their own fines, coffee, tea or herbs. Optionally they can dispose of the bag.

As a third embodiment, the first design of the first embodiment may have an additional, foldable, centrally creased bottom polymer sheet that is heat welded to the two side sheets. With this design the spout 12 will be heat sealed above the bottom of the bag, onto the sides. It will function identical to the first embodiment bag 2 but will have the vertical self standing ability.

Although discussed in use with nut fines for the development of nutmilk, this system also works excellent as a cold press for coffee, tea or medicinal herbs and powders.

As discussed earlier, each compartment can vary in its volumetric capacity (size) based on the location of the polymer water permeable mesh 14 within the bag 2. The volumetric capacity of either compartment can actually each be brought to zero. (That is to say if all of the fluid was squeezed from either compartment or if the mesh 14 were pressed tight to completely touch either of the side sheets.) The bag 2 itself has a maximum volume V which is the summation of V1 (the volume of the first compartment 4) and V2 (the volume of the second compartment 6). However, V1 is dependant on the amount of nut fines placed in the first compartment and the volume of fluid squeezed up from the bottom of the bag and across the mesh panel.

While certain features and aspects have been described with respect to exemplary embodiments, one skilled in the art will recognize that numerous modifications are possible. For example rather than using a single polymer sheet as the alternate embodiment, a polymer sleeve, open at both ends may also be used. Further, while various methods and processes described herein may be described with respect to particular structural and/or functional components for ease of description, methods provided by various embodiments are not limited to any particular structural and/or functional architecture, but instead can be implemented on any suitable physical structure. Similarly, while certain functionality is ascribed to certain system components, unless the context dictates otherwise, this functionality can be distributed among various other system components in accordance with the several embodiments.

Hence, while various embodiments are described with—or without—certain features for ease of description and to illustrate exemplary aspects of those embodiments, the various components and/or features described herein with respect to a particular embodiment can be substituted, added, and/or subtracted from among other described embodiments, unless the context dictates otherwise. Consequently, although several exemplary embodiments are described above, it will be appreciated that the invention is intended to cover all modifications and equivalents within the scope of the following claims.

Having thus described the invention, what is claimed as new and desired to be secured by Letters Patent is as follows:

1. A nut milk extraction bag, comprising:
a first fluid impermeable side sheet having a first proximal end, a first distal end, a first left edge and a first right side edge;
an opposable fluid impermeable second side sheet having a second proximal end, a second distal end, a left second side edge and a right second side edge;
a moveable, fluid permeable central mesh panel having a third proximal end, a third distal end, a third left side edge and a third right side edge;
a pour spout affixed at said first and second distal ends; and
a reuseable seal operationally engageable between said first proximal end and said second proximal end; wherein
said mesh panel resides sandwiched between said first side sheet and said second side sheet such that said third proximal end is continually sealed to said first side sheet and said third distal end is continually sealed to said second side sheet, and said all right side edges are continually sealed together and said all left side edges are continually sealed together such that said mesh panel divides said bag into a first inner compartment and a second inner, adjacent compartment separated by said mesh panel.

2. The nut milk extraction bag of claim 1 wherein said pour spout further comprises:
a cylindrical body having a distal end and a proximal end; and
an udder shaped cap matingly engageable with said cylindrical body and rotatable on said cylindrical between an open and closed flow position.

3. The nut milk extraction bag of claim 2 wherein said pour spout has a pair of heat sealable wings extending normally therefrom, said heat sealable wings having a series of gusset ribs extending normally between said body and said heat sealable wings.

4. The nut milk extraction bag of claim 3 wherein said udder shaped cap has a hemispherical body with a central orifice therein and with three nipples extending therefrom, said nipples spaced 120 radial degrees apart, with one of said nipples having a longitudinal bore formed there through, said bore intersecting said central orifice in said hemispherical body.

5. The nut milk extraction bag of claim 1 wherein each compartment has one wall of a fluid permeable mesh panel and one wall of a fluid impermeable sheet.

6. The nut milk extraction bag of claim 5 wherein said third proximal end is sealed adjacent to said first proximal end and said third distal end is sealed between said second distal end and said second proximal end.

7. The nut milk extraction bag wherein said first fluid impermeable side sheet and said second fluid impermeable side sheet are made of a polymer that can be frozen, microwaved, boiled, refrigerated, and washed.

8. The nut milk extraction bag of claim 1 wherein said first fluid impermeable side sheet and said second fluid impermeable side sheet are made of a polyethylene/nylon plastic in the range of 2-6 mil thick.

9. The milk nut extraction bag of claim 1 wherein said first compartment has a variable volumetric capacity.
